(19) United States
(12) Patent Application Publication
(10) Pub. No.: US 2017/0104347 A1
(43) Pub. Date: Apr. 13, 2017

(54) SECONDARY BATTERY APPARATUS

(71) Applicant: DENSO CORPORATION, Kariya-city (JP)

(72) Inventors: Yuta SHIMONISHI, Kariya-city (JP); Yoshinori SATOU, Kariya-city (JP); Shigeki KOMINE, Kariya-city (JP); Yoshikazu KUSANO, Kariya-city (JP)

(73) Assignee: DENSO CORPORATION, Kariya-city (JP)

(21) Appl. No.: 15/290,080

(22) Filed: Oct. 11, 2016

(30) Foreign Application Priority Data
Oct. 9, 2015 (JP) 2015-200660

(51) Int. Cl. H02J 7/00; H01M 4/525; H01M 10/42; H01M 4/587; H01M 10/0569; H01M 10/0562; H01M 10/0525; H01M 4/38

(52) U.S. Cl. CPC H02J 7/007; H01M 10/0525; H01M 4/525; H01M 4/387; H01M 4/587; H01M 10/0569; H01M 10/0562; H01M 10/425; H01M 2300/0037; H01M 2300/0068; H01M 2010/4271

(57) ABSTRACT

A secondary battery has a positive electrode and a negative electrode, and is charged and discharged. A charge-discharge control unit controls charge and discharge of the secondary battery, and includes a storage unit, a calculating unit, and a control processing unit. The storage unit stores therein charge-discharge characteristics of the secondary battery. The calculating unit calculates a charge-discharge condition of the secondary battery based on the charge-discharge characteristics stored in the storage unit. The control processing unit charges and discharges the secondary battery based on the charge-discharge condition. The storage unit stores therein model data of degradation. The calculating unit compares the model data of degradation with charge-discharge data of when the secondary battery is charged and discharged, calculates charge-discharge characteristics of the positive electrode and charge-discharge characteristics of the negative electrode, and determines the charge-discharge condition of the secondary battery based on the calculated charge-discharge characteristics.

### CROSS-REFERENCE TO RELATED APPLICATION

This application is based on and claims the benefit of priority from Japanese Patent Application No. 2015-200660, filed Oct. 9, 2015. The entire disclosure of the above application is incorporated herein by reference.

### BACKGROUND

Technical Field

The present disclosure relates to a secondary battery apparatus that includes a charge-discharge unit that controls charge and discharge of a secondary battery.

Related Art

In accompaniment with the proliferation of laptop computers, mobile phones, digital cameras, and the like, there is a growing demand for secondary batteries used to drive such compact electronic apparatuses. The use of nonaqueous electrolyte secondary batteries (particularly lithium ion secondary batteries) is becoming more popular for these electronic apparatuses, because higher capacity can be achieved.

The application of nonaqueous electrolyte secondary batteries for purposes requiring large amounts of power, such as in vehicles (electric vehicles [EVs], hybrid vehicles [HVs], and plug-in hybrid vehicles [PHVs]) and household power supplies (home energy management systems [HEMSs]), in addition to use in compact electronic apparatuses, is being discussed. In this case, a large amount of power can be obtained through means such as increasing the size of an electrode plate in the nonaqueous electrolyte battery, forming an electrode assembly by laminating numerous electrode plates, or configuring a battery pack (also called an assembled battery) by combining numerous battery cells (or secondary batteries).

In recent years, the mounting of nonaqueous electrolyte secondary batteries in vehicles has been promoted in light of environmental issues. In terms of safety, quality control, and durability, the nonaqueous electrolyte secondary battery that is mounted to a vehicle is required to be charged and discharged within a certain voltage range. For example, when a lithium ion secondary battery is excessively charged (commonly referred to as overcharge), oxidation of an electrolytic solution and breakdown of the crystal structure of a positive-electrode active material tend to occur on the positive electrode side. Precipitation of lithium metal tends to occur on the negative electrode side. Consequently, degradation of the secondary battery progresses. To prevent such problems, the lithium ion secondary battery (or the nonaqueous electrolyte secondary battery) is required to be handled in a manner preventing overcharge and over-discharge, and controlled (charge-discharge control) such as to suppress the progression of degradation and enable long-term use.

In response to this problem, a measure involving appropriate determination of the degradation state of the nonaqueous electrolyte secondary battery and control of a cutoff voltage based on the state is being considered, for the purpose of preventing overcharge and over-discharge.

However, degradation of the nonaqueous electrolyte secondary battery widely varies depending on usage conditions (such as ambient temperature, electrode temperature, state-of-charge (SOC) range over which charge and discharge are performed, and charge-discharge rate). In addition, degradation also varies depending on manufacturing conditions (such as moisture contamination during mixing in the preparation process of the battery, heat generation conditions, and charge-discharge conditions before shipping of the battery) of the secondary battery. Therefore, it is difficult to determine the state (degree of degradation) of the nonaqueous electrolyte secondary battery with high accuracy. Moreover, the above-described problem becomes even more significant when atomization of an active material is performed to ensure sufficient battery performance, and when a positive-electrode active material containing Ni²⁺ is used to increase the capacity of the active material.

Regarding this problem, JP-2013-81332 describes acquiring data on charge-discharge characteristics based on the degree of degradation of a battery module from a database stored in advance based on manufacturing inspections and operation results, and performing charge-discharge control to determine an operation pattern based on the acquired data.

However, in the conventional control method, a problem occurs in that an accurate determination cannot be made regarding the degradation of the secondary battery. Specifically, in the conventional control method, the data stored in advance in the database based on manufacturing inspections and operation results is data obtained in a state in which the secondary battery is assembled. Electrode reaction at the positive electrode and electrode reaction at the negative electrode simultaneously occur in the secondary battery. Therefore, even if either of the electrodes is degraded (specifically, the rate of either electrode reaction is limited), an accurate determination of the degradation is difficult. Furthermore, when degradation of an electrode progresses without being detected by monitoring of the secondary battery alone, degradation that suddenly emerges after repeat charge and discharge may also occur. Such type of degradation is difficult to accurately detect.

### SUMMARY

It is thus desired to provide a secondary battery apparatus that is capable of achieving high charge-discharge performance, even when degradation of a secondary battery occurs.

To solve the above-described problems, the inventors of the present disclosure have completed the present disclosure by repeatedly examining the secondary battery apparatus.

An exemplary embodiment of the present disclosure provides a secondary battery apparatus that includes: a secondary battery that has a positive electrode and a negative electrode, and is charged and discharged; and a charge-discharge control unit that controls charge and discharge of the secondary battery. In the secondary battery apparatus, the charge-discharge control unit includes: a storage unit that stores therein charge-discharge characteristics of the secondary battery; a calculating unit that calculates a charge-discharge condition of the secondary battery based on the charge-discharge characteristics stored in the storage unit; and a control processing unit that charges and discharges the secondary battery based on the charge-discharge condition. The storage unit stores therein model data of degradation of the positive electrode, the negative electrode, and the secondary battery. The calculating unit compares the model data with charge-discharge data of when the secondary battery is charged and discharged, calculates the charge-discharge characteristics of the positive electrode and the charge-discharge characteristics of the negative electrode, and determines the charge-discharge condition of the secondary battery based on the calculated charge-discharge characteristics.

In the secondary battery apparatus of the present disclosure, the charge-discharge control unit that controls charge and discharge of the secondary battery compares the model data with the charge-discharge data of when the secondary battery is charged and discharged. The charge-discharge control unit calculates the charge-discharge characteristics of the positive electrode and the negative electrode of the secondary battery. The charge-discharge control unit then performs charge and discharge of the secondary battery based on the calculated charge-discharge characteristics. As a result, charge and discharge matching the degrees of deterioration in the positive electrode and the negative electrode (that is, decrease in performance of the electrodes) can be performed. Decrease in performance of the overall secondary battery can be suppressed. As a result, high battery performance can be achieved.

### BRIEF DESCRIPTION OF THE DRAWINGS

In the accompanying drawings:

FIG. 1 is a diagram of a configuration of a secondary battery apparatus according to an embodiment;

FIG. 2 is a diagram of a configuration of a secondary battery used in the embodiment; and

FIG. 3 is a flowchart of an operation performed by the secondary battery apparatus according to the embodiment

### DESCRIPTION OF THE EMBODIMENTS

The present disclosure will hereinafter be described in detail according to an embodiment. Specifically, the present disclosure will be described based on a secondary battery apparatus that uses a lithium ion secondary battery.

### EMBODIMENT

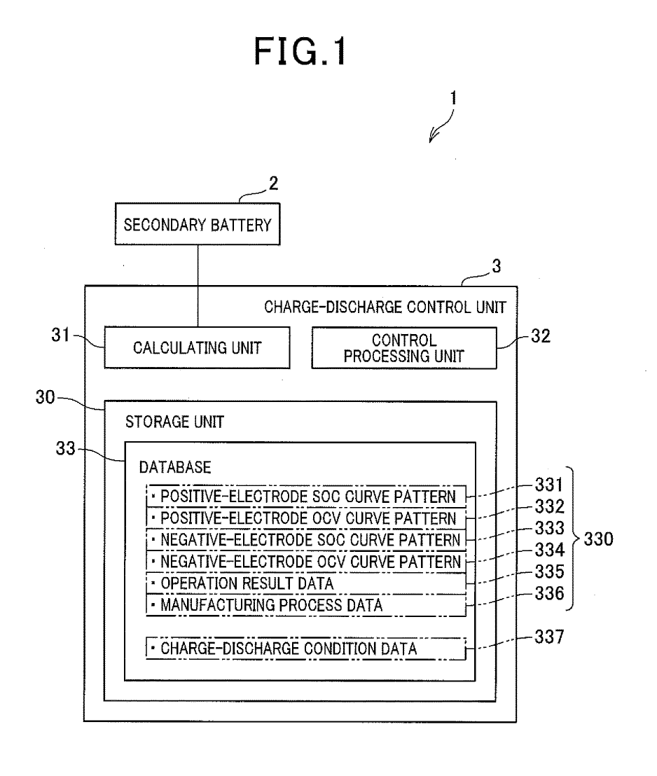

A secondary battery apparatus 1 according to the present embodiment uses a lithium ion secondary battery as a secondary battery. The secondary battery apparatus 1 according to the present embodiment has a lithium ion secondary battery 2 and a charge-discharge control unit 3. FIG. 1 schematically shows a configuration of the secondary battery apparatus 1 according to the present embodiment.

### [Lithium Ion Secondary Battery]

The lithium ion secondary battery 2 (referred to, hereafter, as a secondary battery 2) has a positive electrode 20 and a negative electrode 21. The secondary battery 2 is charged and discharged by the charge-discharge control unit 3. The configuration of the secondary battery 2 is not limited. The secondary battery 2 can have a configuration similar to that of a conventional lithium ion secondary battery. In addition, the secondary battery 2 may be a single battery or a battery pack combining a plurality of secondary batteries 2. When the battery pack is formed, the plurality of secondary batteries 2 may be combined by serial connection, parallel connection, or a combination of serial and parallel connections.

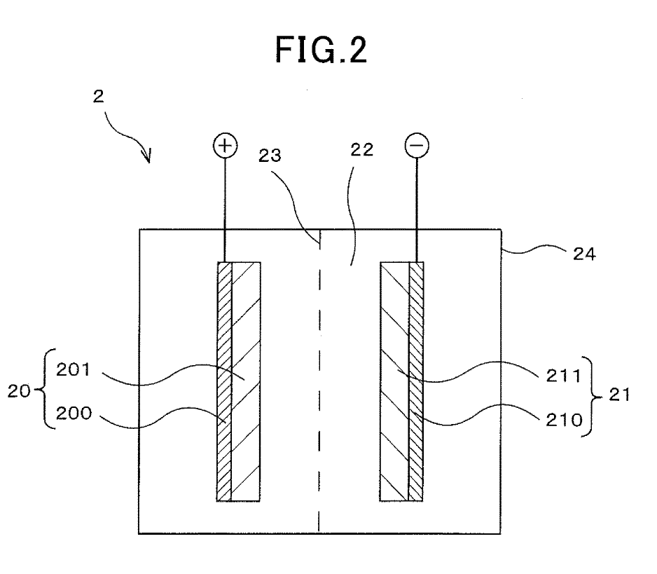

The secondary battery 2 has the positive electrode 20, the negative electrode 21, and a nonaqueous electrolyte 22. FIG. 2 shows the configuration of the secondary battery 2.

### [Positive Electrode]

The positive electrode 20 has a positive-electrode active material layer 201 on a surface of a positive-electrode collector 200. The positive-electrode active material layer 201 contains a positive-electrode active material. The positive-electrode active material layer 201 is formed by a positive-electrode mixture being applied to the surface of the positive-electrode collector 200 and dried (formed by coating). The positive-electrode mixture is obtained by the positive-electrode active material, a conductive material, and a binding material being mixed. The conductive material and the binding material are arbitrary and may optionally not be mixed with the positive-electrode active material. The positive-electrode mixture is in the form a paste (slurry) through use of an appropriate solvent.

### [Positive-Electrode Active Material]

The positive-electrode active material is not limited, other than being required to be capable of absorbing and releasing lithium ions. For example, the positive-electrode active material may include various oxides, sulfides, lithium-containing oxides, and conductive polymers. A lithium-transition metal complex oxide is preferably used as the positive-electrode active material.

The lithium-transition metal complex oxide is preferably used as the positive-electrode active material described above. More preferably, a complex oxide having a layered structure, a complex oxide having a spinel structure, or a complex oxide having a polyanionic structure is used. From the perspective of increasing capacity, a complex oxide containing Ni²⁺ is even more preferable as the positive-electrode active material, because oxidation-reduction reaction of Ni²⁺ and NO⁴⁺ can be used. A complex oxide having a layered, rock-salt type crystal structure is the most preferable.

The complex oxide having a layered rock-salt structure includes LiM₁₋ₓAₓO₂ (where x<1.0; M represents at least one type of metal element selected from Mn, Fe, Co, Ni, and Cu; and A represents at least one type of element selected from Al, Si, P, Ti, Mg, Na, Sn, Ga, Ge, B, and Nb). The complex oxide having a layered rock-salt structure more preferably contains Ni²⁺ (has a configuration in which M of the foregoing compositional formula contains at least Ni).

As a result of the element represented by A in the foregoing compositional formula being optimally selected, the complex oxide having a layered rock-salt structure is capable of improving safety and durability of the positive-electrode active material. That is, a high-capacity, high-voltage secondary battery 2 having excellent battery performance can be achieved.

The complex oxide having a layered rock-salt structure preferably contains at least either of elements Sn and Ge. Sn and Ge are contained in the form of ions such as Sn⁴⁺ and Ge⁴⁺. A substance group of a layered rock-salt type crystal structure or the like containing these ions is configured to be contained in the crystal, because the valence of the transition metal contained therein is relatively low. That is, when the complex oxide having a layered rock-salt structure contains Ni, Ni²⁺ can be more easily stably held. In other words, the above-described effects can be more easily achieved. Furthermore, these elements form strong covalent bonds with oxygen. As a result, improvement in durability and safety can be expected.

The complex oxide having a layered, rock-salt structure preferably has a crystallite size of 100 nm or less. As a result of the crystallite size being set to this range, the above-described effects can be reliably achieved. When the crystallite size increases such as to exceed 100 nm, reactivity decreases. The crystallite size is more preferably 80 nm or less. In the present embodiment, for example, the positive-electrode active material has a crystallite size of 60 nm or less.

The positive-electrode active material is preferably the complex oxide having a layered, rock-salt structure. However, in addition to the complex oxide having a layered rock-salt structure, the positive-electrode active material may be a mixture of the complex oxide having a layered rock-salt structure and a positive-electrode active material that has been conventionally well-known. In this case, the mixing ratio of the mixture is not limited. However, from the perspective of increasing capacity, for example, the mass of the complex oxide having a layered rock-salt structure is preferably 50 mass percent or more when the total mass of the positive-electrode active material is 100 mass percent.

The positive-electrode active material that has been conventionally well-known since the past includes the above-described complex oxide having a spinel structure and complex oxide having a polyanionic structure.

For example, the complex oxide having a spinel structure includes LiNiₓM_{y}Mn_{z}O₄ (where M represents at least one type of metal element selected from transition metals excluding Ni and Mn, and may arbitrarily contain at least one type of element selected from Al, Mg, Ca, Ge, and Sn; x+y+z=2; and 0≦x, y, z<2).

The complex oxide having a polyanionic structure includes LiₓMn_{y}M_{1-y}X_{z}O_{4-z} (where M represents at least one type of metal element selected from transition metals excluding Mn; X represents at least one type of element selected from P, As, Si and Mo, and may arbitrarily contain at least one type of element selected from Al, Mg, Ca, Zn, and Ti; 0<x<1.0; 0≦y<1.0; and 1≦z≦1.5).

The manufacturing method of the positive-electrode active material is not limited. The positive-electrode active material can be manufactured using a manufacturing method that is conventionally well-known. The positive-electrode active material may form secondary particles that are an agglomeration of primary particles. The shape of the primary particle is not limited, and may include a scale shape, a spherical shape, and a potato-like shape (or an irregular shape). From the perspective of reactivity, the shorter diameter of the primary particle is preferably 1 μm or less, and more preferably 0.5 μm (500 nm) or less. The primary particle is more preferably a substantially spherical particle having a particle size (such as an average particle diameter, D50) of 1 μm or less. Still more preferably, the particle size of the primary particle is 0.5 μm (500 nm) or less.

### [Conductive Material, Binding Material, Positive-Electrode Mixture, and Positive-Electrode Collector]

The conductive material donates and receives electrons produced from the positive-electrode active material. A material having conductivity is used as the conductive material. For example, the conductive material includes carbon materials and conductive polymer materials. As the carbon material, Ketjenblack (registered trademark), acetylene black, carbon black, graphite, carbon nanotube, amorphous carbon, or the like can be used. As the conductive polymer material, polyaniline, polypyrrole, polythiophene, polyacetylene, or polyacene can be used. When the conductive polymer material is used as the conductive material, the conductive material achieves the effects of the binding material in addition to the effects of the conductive material.

The binding material binds constituent elements, such as the positive-electrode active material, and forms the positive electrode 20. Various polymer materials can be used as the binding material. Polymer materials that have high chemical and physical stability are preferable. For example, the polymer material includes polyvinylidene fluoride (PVDF), polytetrafluoroethylene (PTFE), ethylene propylene diene monomer (EPDM) rubber, styrene-butadiene rubber (SBR), nitrile rubber (NBR), fluororubber, and acrylic binders. An organic solvent that dissolves the binding material is typically used as the solvent in the positive-electrode mixture. For example, the organic solvent includes N-methyl-2-pyrrolidone (NMP), dimethylformamide, dimethylacetamide, methyl ethyl ketone, cyclohexanone, methyl acetate, methyl acrylate, diethylenetriamine, N,N-dimethylaminopropylamine, ethylene oxide, and tetraphydrofuran However, the organic solvent is not limited thereto. In addition, in some cases, the positive-electrode active material may be formed into a slurry by PTFE or the like, through addition of a dispersant, a thickener, or the like to water.

A conventional collector can be used as the positive-electrode collector 200. A processed metal, such as aluminum, can be used. That is, for example, a metal foil, a metal mesh, a punched metal, or a foamed metal that is processed into a sheet shape can be used. However, the positive-electrode collector 200 is not limited thereto.

The thickness of the positive-electrode collector 200 is not limited. The positive-electrode collector 200 can have a thickness that is similar to that of a known positive-electrode collector. The thickness of the positive-electrode collector 200 is preferably 20 μm or less. For example, a foil having a thickness of about 15 μm is preferably used.

The positive-electrode active material layer 201 of the positive electrode 20 can have an arbitrary layered structure composed of a single layer, or two or more layers. When the positive-electrode active material layer 201 has a layered structure composed of two or more layers, the configuration of each layer may be the same or may differ. For example, a configuration may be used in which a layer composed only of the conductive material and the binding material is formed as a first layer and a layer containing the above-described positive-electrode active material is formed as a second layer.

### [Negative Electrode]

The negative electrode 21 contains a negative-electrode active material. The negative electrode 21 has a negative-electrode active material layer 211 on a surface of a negative-electrode collector 210. The negative-electrode active material layer 211 is formed by a negative-electrode mixture being applied to the surface of the negative-electrode collector 210 and dried (formed by coating). The negative-electrode mixture is obtained by the negative-electrode active material and a binding material being mixed. The negative-electrode mixture is in the form a paste (slurry) through use of an appropriate solvent.

### [Negative-Electrode Active Material]

A conventional negative-electrode active material can be used as the negative-electrode active material of the negative electrode 21. For example, the negative-electrode active material includes that containing at least one element among Sn, Si, Sb, Ge, C, and Ti. Among such negative-electrode active materials, the negative-electrode active material containing C is preferably a carbon material that is capable of absorbing and releasing electrolyte ions of the lithium ion secondary battery (has Li-absorption capability). The negative-electrode active material containing C is more preferably graphite.

In addition, among such negative-electrode active materials, the negative-electrode active materials containing Sn, Sb, or Ge, in particular, are metal alloys that exhibit significant volumetric change. These negative-electrode active materials may form alloys with other metals, such as Ag—Sn, Sn—Sb, and Cu—Sn.

### [Conductive Material, Binding Material, Negative-Electrode Mixture, and Negative-Electrode Collector]

Carbon materials, metal powders, conductive polymers, and the like can be used as the conductive material of the negative electrode 21. From the perspective of conductivity and stability, a carbon material such as acetylene black, Ketjenblack (registered trademark), or carbon black is preferably used.

The binding material of the negative electrode 21 includes polytetrafluoroethylene (PTFE), polyvinylidene fluoride (PVDF), fluoroplastic copolymer (fluorinated ethylene-propylene copolymer or tetrafluoroethylene-hexafluoropropylene copolymer), styrene butadiene rubber (SBR), acrylic rubber, fluororubber, polyvinyl alcohol (PVA), styrene-maleic resin, polyacrylate, carboxymethyl cellulose (CMC), and the like.

The solvent in the negative-electrode mixture of the negative electrode 21 includes organic solvents such as N-methyl-2-pyrrolidone (NMP), water, and the like.

A conventional collector can be used as the negative-electrode collector 210. A processed metal, such as copper, stainless steel, titanium, or nickel, can be used. That is, for example, a metal foil, a metal mesh, a punched metal, or a foamed metal that is processed into a sheet shape can be used. However, the negative-electrode collector 210 is not limited thereto.

The negative-electrode active material layer 211 of the negative electrode 21 can have an arbitrary layered structure composed of a single layer, or two or more layers. When the negative-electrode active material layer 211 has a layered structure composed of two or more layers, the configuration of each layer may be the same or may differ. For example, a configuration may be used in which a layer composed only of the conductive material and the binding material is formed as a first layer and a layer containing the above-described negative-electrode active material is formed as a second layer. [Nonaqueous electrolyte] The nonaqueous electrolyte 22 is a medium that transports charge carriers, such as electrolyte ions, between the positive electrode 20 and the negative electrode 21. Although not particularly limited, the nonaqueous electrolyte 22 is preferably physically, chemically, and electrically stable under an atmosphere (environment) in which the secondary battery 2 is used.

A conventional nonaqueous electrolyte can be used as the nonaqueous electrolyte 22. The nonaqueous electrolyte 22 includes that in which a supporting electrolyte is dissolved in a nonaqueous solvent. A conventional additive may also be added.

The supporting electrolyte is not limited, other than being required to contain lithium. For example, the supporting electrolyte is preferably at least one type among an inorganic salt selected from LiPF₆, LiBF₄, LiClO₄, and LiAsF₆, a derivative of these inorganic salts, an organic salt selected from LiSO₃CF₃, LiC(SO₃CF₃)₃, LiN(SO₂CF₃)₂, LiN(SO₂C₂F₅)₂, and LiN(SO₂CF₃)(SO₂C₄F₉), and a derivative of these organic salts. These supporting electrolytes can further improve battery performance and can maintain higher battery performance even in temperature ranges other than room temperature. The concentration of the supporting electrolyte is also not particularly limited, and is preferably selected as appropriate taking into consideration the type of supporting electrolyte and the type of organic solvent.

The nonaqueous solvent dissolves the supporting electrolyte. The nonaqueous solvent is not limited, other than being required to dissolve the supporting electrolyte. For example, carbonates, halogenated hydrocarbons, ethers, ketones, nitriles, lactones, and oxirane compounds can be used. In particular, propylene carbonate, ethylene carbonate (EC), 1,2-dimethoxyethane, dimethyl carbonate (DMC), diethyl carbonate (DEC), ethyl methyl carbonate (EMC), vinylene carbonate (VC), or a mixed solvent thereof is preferable. Use of a nonaqueous solvent that is one type or more selected from a group comprising carbonates and ethers, in particular, among the organic solvents, is preferable. A reason for this is that solubility, dielectric constant, and viscosity of the supporting electrolyte are excellent, and charge-discharge efficiency of the secondary battery 2 improves.

The conventional additive decomposes on the surface of an electrode (positive electrode, according to the present embodiment) and forms a film (such as a solid electrolyte interphase [SET] film) on the surface of the electrode (i.e., positive electrode, particularly the positive-electrode active material), when the battery is assembled. The film that is formed on the surface of the electrode (positive electrode) exhibits high stability. Even when the electrical potential at the positive electrode becomes high (such as when a charge reaction progresses at a high potential), the film covers the surface of the electrode (i.e., positive electrode) without decomposing. As a result, decrease in the capacity of the electrode (i.e., positive electrode) is suppressed by the film.

In addition, the nonaqueous electrolyte 22 includes solid electrolytes. The solid electrolyte that can be used as the nonaqueous electrolyte 22 includes a solid electrolytic material in which polyethylene oxide contains lithium bis(trifluoromethanesulfonyl)imide (LiTFSI) or the like, and at least one inorganic solid electrolytic material selected from a group comprising a perovskite type, sodium super ionic conductor (NASICON) type, lithium super ionic conductor (LISICON) type, thio-LISICON type, γ-Li₃PO₄ type, garnet type, and lithium phosphorous oxynitride (LIPON) type.

### [Other Configurations]

In the secondary battery 2, the positive electrode 20 and the negative electrode 21 are housed inside a battery case 24, thorough a separator 23, together with the nonaqueous electrolyte 22, in a state in which the positive-electrode active material layer 201 and the negative-electrode active material layer 211 oppose each other.

### [Separator]

The separator 23 provides electrical insulation between the positive electrode 20 and the negative electrode 21. The separator 23 also imparts ion conductivity. The separator 23 serves the role of holding the nonaqueous electrolyte 22. For example, a porous synthetic resin film, particularly a porous film, a nonwoven fabric, or the like composed of a polyolefin polymer (polyethylene or polypropylene), cellulose, or glass fibers, is preferably used as the separator 23.

When a solid electrolyte is used as the nonaqueous electrolyte 22 in the secondary battery 2, a solid electrolyte that achieves both electrical insulation and ion conductivity is preferably used between the positive electrode 20 and the negative electrode 21. As the solid electrolyte, a polymer solid electrolyte having a matrix formed of a polyethylene oxide, or a Li₂S—P₂S-based inorganic solid electrolyte or the like is used. Moreover, for example, a gel-like solid electrolyte and the above-described separator may be used in combination.

### [Battery Case]

In the battery case 24, the positive electrode 20 and the negative electrode 22 are housed (encapsulated), through the separator 23, together with the nonaqueous electrolyte 22. The battery case 24 is composed of a material that inhibits transmittance of moisture between the interior and the exterior. Such a material may include a material having a metal layer. The material having a metal layer may include the metal itself, as well as a laminated film.

When the positive terminal 20 and the negative terminal 21 are housed in the battery case 24, the secondary battery 2 has electrode terminals that electrically connect the positive electrode 20 and the negative electrode 21 inside the battery case 24 to the outside.

### [Charge-Discharge Control Unit]

The charge-discharge control unit 3 controls charge and discharge of the secondary battery 2. The charge-discharge control unit 3 includes a storage unit 30, a calculating unit 31, and a control processing unit 32. The storage unit 30 stores therein charge-discharge characteristics of the secondary battery 2. The calculating unit 31 calculates a charge-discharge condition of the secondary battery 2 based on the charge-discharge characteristics stored in the storage unit 30. The control processing unit 32 charges and discharges the secondary battery 2 based on the charge-discharge condition. The charge-discharge control unit 3 corresponds to a charge-discharge control unit.

In addition, the charge-discharge control unit 3 has a detecting unit that detects the charge and discharge of the secondary battery 2. The detecting unit is not shown. The detecting unit detects the voltage and the current of the secondary battery 2. The detection results are then used for calculation of the SOC of the secondary battery 2 and the like.

The charge-discharge control unit 3 is composed of a computer (or a micro-control unit [MCU]), and includes a central processing unit (CPU), a read-only memory (ROM), a random access memory (RAM), an input/output (I/O), and the like. The CPU is capable of running a program stored in the ROM and the like as appropriate. As a result, optimal SOC detection and control can be performed within a system.

As shown in FIG. 1, the storage unit 30 includes a database 33 that stores therein the charge-discharge characteristics of the secondary battery 2. The charge-discharge characteristics include model data 330 on the degradation of the positive terminal 20, the negative terminal 21, and the secondary battery 2.

The model data 330 can be data determined from initial charge-discharge data and post-degradation charge-discharge data. The initial charge-discharge data is obtained at a conditioning step at which charge and discharge are performed immediately after assembly of the secondary battery 2. The post-degradation charge-discharge data is obtained after the secondary battery 2 is operated. Here, operation of the secondary battery 2 includes the secondary battery 2 being left to stand over a long period of time. That is, the post-degradation charge-discharge data includes charge-discharge data after degradation due to degradation over time when the secondary battery 2 is left standing over a long period of time.

As shown in FIG. 1, the database 33 of the storage unit 30 stores therein, as the model data 330, at least one of a pattern of an SOC curve of the positive electrode 20 (i.e., positive electrode SOC curve pattern 331), a pattern of an open-circuit voltage (OCV) curve of the positive electrode 20 (i.e., positive electrode OCV curve pattern 332), a pattern of an SOC curve of the negative electrode 21 (i.e., negative electrode SOC curve pattern 333), and a pattern of an OCV curve of the negative electrode 21 (i.e., negative electrode OCV curve pattern 334), before degradation and in each degradation state.

The patterns 331 to 334 for the electrodes 20 and 21 are obtained through measurement of the SOC curve pattern and the OCV curve pattern after the secondary battery 2 is assembled into a half-cell. The half-cell data of the positive electrode 20 and the negative electrode 21 stored in the storage unit 30 may be rewritten after operation of the secondary battery 2. The half-cell refers to a battery cell (secondary battery) in which a counter electrode is a reference electrode. For example, the half-cell is a battery cell of which the counter electrode is lithium metal. The patterns of the characteristics of the electrodes 20 and 21 are stored in the storage unit 30 as the model data. As a result, an optimal charge-discharge condition for each of the electrode 20 and 21 can be determined.

In a similar manner, the database 33 of the storage unit 30 also stores therein model data (i.e., manufacturing process data 336) based on differences in manufacturing steps, as the model data 330. Battery performance of the lithium ion secondary battery is known to be affected by the manufacturing steps. Specifically, variations in battery performance occur as a result of the effects of the atmosphere (moisture in the atmosphere) during manufacturing. As a result of the model data (i.e., manufacturing process data 336) based on differences in manufacturing steps also being stored, a more suitable charge-discharge condition can be determined.

Furthermore, the database 33 of the storage unit 30 stores therein operation result data 335. The operation result data 335 includes detection results from the detecting unit, SOC calculation results, and the like, when charge and discharge of the secondary battery 2 are repeated in actual use.

In addition, the database 33 of the storage unit 30 stores therein charge-discharge condition data 337 that corresponds to the charge-discharge characteristics (charge-discharge characteristics calculated by the calculating unit 31, described hereafter) of the secondary battery 2. A plurality of pieces of charge-discharge condition data 337 are stored. The charge-discharge condition data 337 can be determined based on the charge-discharge characteristics.

The calculating unit 31 compares the model data 330 with the charge-discharge data of when the secondary battery 2 is charged and discharged. The calculating unit 31 then calculates the charge-discharge characteristics of the positive electrode 20 and the charge-discharge characteristics of the negative electrode 21. The calculating unit 31 determines the charge-discharge condition of the secondary battery 2 based on the calculated charge-discharge characteristics.

The charge-discharge characteristics of the positive electrode 20 and the negative electrode 21 calculated by the calculating unit 31 are charge-discharge characteristics over the period of time in which the calculating unit 31 performs calculation. The charge-discharge characteristics are battery characteristics of the positive electrode 20 and the negative electrode 21 including degradation caused by the operation performed up to the point immediately before the calculation. The battery characteristics include subsequent degradation resulting from the operation (i.e., subsequent degradation in performance resulting from the operation). That is, as the charge-discharge characteristics of the positive electrode 20 and the negative electrode 21, the calculating unit 31 calculates future degradation (i.e., decrease in performance) of the positive electrode 20 and the negative electrode 21 (i.e., predicts degradation).

The method by which the calculating unit 31 calculates the charge-discharge characteristics of the positive electrode 20 and the negative electrode 21 is not limited. A method in which the calculating unit 31 estimates a single electrode state of the positive electrode from an SOC (state-of-charge) −OCV (open-circuit-voltage) curve and reflects the estimated single electrode state in upper/lower limit voltage control can be used.

The method for determining the charge-discharge characteristics based on the SOC−OCV curve is not limited. Methods that are typically used may be used. For example, the charge-discharge characteristics may be estimated from a location of expression of a plateau region derived from a stage structure of graphite in the negative electrode active material, a plateau region length, and the like. Alternatively, the charge-discharge characteristics may be determined through direct or indirect use of the SOC/OCV curve of a single electrode using a half-cell.

The calculating unit 31 determines the charge-discharge condition of the secondary battery 2 from the calculated charge-discharge characteristics of the positive electrode 20 and the negative electrode 21. The method for determining the charge-discharge condition involves determining the charge-discharge condition optimal for the secondary battery 2 from the calculated charge-discharge characteristics of the positive electrode 20 and the negative electrode 21. For example, when degradation of the positive electrode 20 is predicted from the calculated charge-discharge characteristics, a condition that suppresses degradation of the positive electrode 20 is set as the charge-discharge condition.

The charge-discharge condition is determined by being selected from the charge-discharge condition data 337 of the database 33 stored in the storage unit 30. The operation pattern for charge and discharge is determined based on the selection made from the charge-discharge condition data 337.

The control processing unit 32 charges and discharges the secondary battery 2 based on the charge-discharge condition (i.e., charge-discharge condition data 337). The control processing unit 32 sets the upper- and lower-limit voltages based on the charge-discharge condition (i.e., charge-discharge condition data 337) and acquires the charge-discharge characteristics data based on the degradation of the secondary battery 2 from the database 33 stored in the storage unit 30. In addition, the control processing unit 32 performs charge-discharge control to determine the operation pattern based on the estimated state of the positive electrode 20 and/or the negative electrode 21.

### [Operation of the Secondary Battery Apparatus]

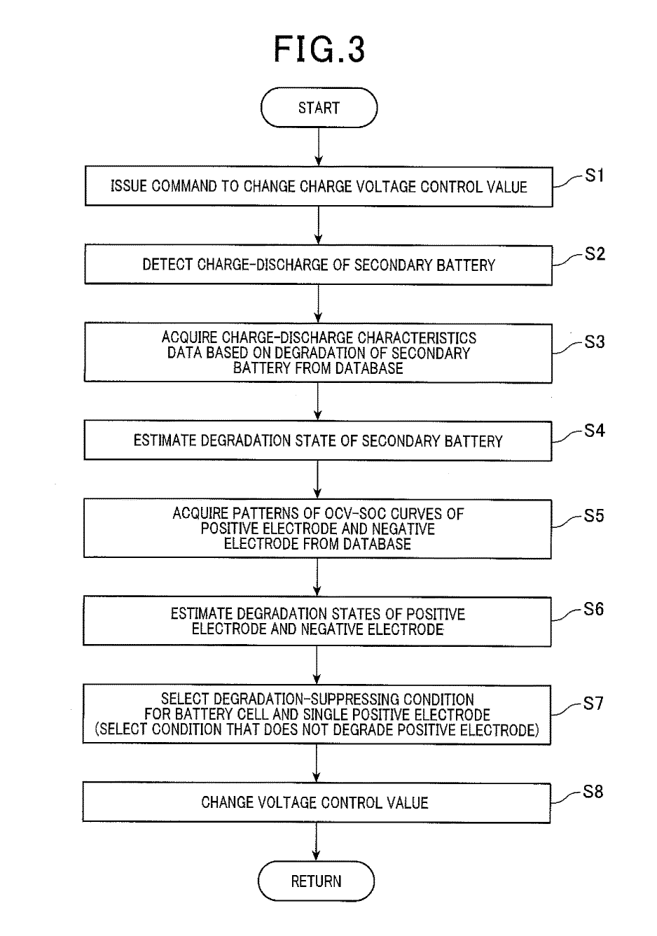

An operation of the secondary battery apparatus 1 according to the present embodiment will be described in detail, using charge-discharge control as an example. FIG. 3 shows a flowchart of the operation of the secondary battery apparatus 1 according to the present embodiment.

As described above, the secondary battery apparatus 1 according to the present embodiment stores predetermined pieces of data in the storage unit 30 of the charge-discharge control unit 3. The secondary battery apparatus 1 repeats charge and discharge under a condition determined in advance. Then, as charge and discharge are repeated, degradation occurs in the positive electrode 20 of the secondary battery 2.

Then, the secondary battery apparatus 1 starts to change a charge voltage control value based on the degradation of the secondary battery 2. Specifically, as shown in FIG. 3, the secondary battery apparatus 1 starts to issue a command to change the charge voltage control value (step S1).

Next, the detection result from the detecting unit is inputted to the calculating unit 31. Specifically, as shown in FIG. 3, the calculating unit 31 detects charge-discharge of the secondary battery 2 (step S2).

Next, the calculating unit 31 acquires the charge-discharge characteristics data (i.e., model data 330 for charge-discharge) based on the degradation of the secondary battery 2 from the database 33 stored in the storage unit 30. Specifically, as shown in FIG. 3, the calculating unit 31 acquires charge-discharge characteristics data based on degradation of the secondary battery 2 from the database 33 (step S3).

Next, the calculating unit 31 compares the inputted detection result with the charge-discharge characteristics data acquired from the storage unit 30, and estimates the degradation state of the secondary battery 2. Specifically, as shown in FIG. 3, the calculating unit 31 estimates the degradation state of the secondary battery 2 (step S4).

Next, the calculating unit 31 acquires the patterns of the OCV−SOC curves of the positive electrode 20 and the negative electrode 21 from the database 33 stored in the storage unit 30 (i.e., model data 330 of the characteristics of each electrode). Specifically, as shown in FIG. 3, the calculating unit 31 acquires patterns 331 to 334 of OCV−SOC curves of the positive electrode 20 and the negative electrode 21 from the database 33 (step S5).

Next, the calculating unit 31 estimates the degradation states of the positive electrode 20 and the negative electrode 21 based on the patterns 331 to 334 of the OCV−SOC curves acquired from the database 33 stored in the storage unit 30. Specifically, as shown in FIG. 3, the calculating unit 31 estimates degradation states of the positive electrode 20 and the negative electrode 21 (step S6).

Next, the calculating unit 31 determines the charge-discharge condition of the secondary battery 2 based on the degradation states of the positive electrode 20 and negative electrode 21. Specifically, as shown in FIG. 3, the calculating unit 31 selects degradation-suppressing condition for the battery cell of the secondary battery 2 and the single electrode of the positive electrode 20, e.g., condition that does not degrade the positive electrode 20 (step S7).

Next, the calculating unit 31 acquires, by selecting, the charge-discharge condition data 337 corresponding to the determined charge-discharge condition from the database 33 stored in the storage unit 30.

Next, in the secondary battery apparatus 1, the control processing unit 32 charges and discharges the secondary battery 2 based on the selected charge-discharge condition data 337. Specifically, as shown in FIG. 3, the control processing unit 32 performs changing of the voltage control value (step S8).

### (First Effect)

The secondary battery apparatus 1 according to the present embodiment has the storage unit 30, the calculating unit 30, and the control processing unit 32. The secondary battery apparatus 1 compares the model data 330 with the charge-discharge data of when the secondary battery 2 is charged and discharged, and calculates the charge-discharge characteristics of the positive electrode 20 and the negative electrode 21 of the secondary battery 2. The secondary battery apparatus 1 then performs charge and discharge of the secondary battery 2 based on the calculated charge-discharge characteristics.

As a result of this configuration, charge-discharge control based on the degree of degradation of the positive electrode 20 and the negative electrode 21 can be performed. Decrease in performance of the overall secondary battery 2 can be suppressed. As a result, the secondary battery apparatus 1 according to the present embodiment can achieve high battery performance.

### (Second Effect)

The model data 330 is determined from the initial charge-discharge data obtained at the conditioning step and the post-degradation charge-discharge data. As a result of this configuration, the model data 330 is that of degradation starting immediately after assembly of the secondary battery 2. The charge-discharge characteristics of the positive electrode 20 and the negative electrode 21 of the secondary battery 2 can be more accurately calculated.

### (Third Effect)

The storage unit 30 stores therein at least one of the pattern 331 of the SOC curve of the positive electrode 20, the pattern 332 of the OCV curve of the positive electrode 20, the pattern 333 of the SOC curve of the negative electrode 21, and the pattern 334 of the OCV curve of the negative electrode 21. As a result of this configuration, the optimal charge-discharge condition for each of the electrodes 20 and 21 can be determined.

### (Fourth Effect)

The charge-discharge characteristics determined by the calculating unit 31 are at least either of the electrical potential and the capacity of each electrode. As a result of this configuration, the charge-discharge characteristics of the positive electrode 20 and the negative electrode 21 can be calculated using the above-described patterns 331 to 334.

### (Fifth Effect)

The positive electrode 20 contains the positive-electrode active material having the layered, rock-salt type crystal structure and containing Ni²⁺. The positive-electrode active material contains at least either of the elements Sn and Ge. In the present embodiment, for example, the positive-electrode active material has a crystallite size of 60 nm or less. As a result of these configurations, safety and durability of the positive electrode 20 and the positive-electrode active material can be improved. As a result, the secondary battery 2 and the positive electrode 20 can be made high-capacity and high-voltage, and have excellent battery performance.

The present disclosure is not limited in any way by the above-described embodiments. The present disclosure can be carried out according to various embodiments without departing from the spirit of the disclosure.

For example, the charge-discharge control unit 3 (including the storage unit 30, calculating unit 31, and control processing unit 32) may be configured by a computer (e.g., a microcomputer or a micro-control unit) that includes a processor (e.g., a central processing unit) and a non-transitory computer-readable storage medium (e.g., read-only memory) storing a program enabling the computer to perform the above-mentioned functions of the charge-discharge control unit 3, e.g., expressed by steps S1 to S8 of FIG. 3.

What is claimed is:

1. A secondary battery apparatus comprising:
a secondary battery that has a positive electrode and a negative electrode, and is charged and discharged; and
a charge-discharge control unit that controls charge and discharge of the secondary battery, wherein
the charge-discharge control unit includes:
a storage unit that stores therein charge-discharge characteristics of the secondary battery;
a calculating unit that calculates a charge-discharge condition of the secondary battery based on the charge-discharge characteristics stored in the storage unit; and
a control processing unit that charges and discharges the secondary battery based on the charge-discharge condition,
the storage unit stores therein model data of degradation of the positive electrode, the negative electrode, and the secondary battery, and
the calculating unit compares the model data with charge-discharge data of when the secondary battery is charged and discharged, calculates the charge-discharge characteristics of the positive electrode and the charge-discharge characteristics of the negative electrode, and determines the charge-discharge condition of the secondary battery based on the calculated charge-discharge characteristics.

2. The secondary battery apparatus according to claim 1, wherein:
the model data is determined from initial charge-discharge data obtained at a conditioning step at which charge and discharge are performed immediately after assembly of the secondary battery, and post-degradation charge-discharge data obtained after the secondary battery is operated.

3. The secondary battery apparatus according to claim 2, wherein:
the storage unit stores therein at least one of a pattern of a state-of-charge curve of the positive electrode, a pattern of an open-circuit voltage curve of the positive electrode, a pattern of a state-of-charge curve of the negative electrode, and a pattern of an open-circuit voltage curve of the negative electrode.

4. The secondary battery apparatus according to claim 3, wherein:
the charge-discharge characteristics determined by the calculating unit are at least either of electrical potential and capacity of each electrode.

5. The secondary battery apparatus according to claim 4, wherein:
the positive electrode contains a positive-electrode active material having a layered, rock-salt type crystal structure and containing Ni²⁺.

6. The secondary battery apparatus according to claim 5, wherein:
the positive-electrode active material contains at least one of elements Sn and Ge.

7. The secondary battery apparatus according to claim 6, wherein:
the positive-electrode active material has a crystallite size of 100 nm or less.

8. The secondary battery apparatus according to claim 1, wherein:
the storage unit stores therein at least one of a pattern of a state-of-charge curve of the positive electrode, a pattern of an open-circuit voltage curve of the positive electrode, a pattern of a state-of-charge curve of the negative electrode, and a pattern of an open-circuit voltage curve of the negative electrode.

9. The secondary battery apparatus according to claim 1, wherein:
the charge-discharge characteristics determined by the calculating unit are at least either of electrical potential and capacity of each electrode.

10. The secondary battery apparatus according to claim 1, wherein:
the positive electrode contains a positive-electrode active material having a layered, rock-salt type crystal structure and containing Ni²⁺.

11. The secondary battery apparatus according to claim 10, wherein:
the positive-electrode active material contains at least one of elements Sn and Ge.

12. The secondary battery apparatus according to claim 1, wherein:
the positive-electrode active material has a crystallite size of 100 nm or less.

13. A method for controlling charge and discharge of a secondary battery that includes a positive electrode and a negative electrode, the method comprising:
storing, in a storage unit, charge-discharge characteristics of the secondary battery;
calculating, by a charge-discharge control unit, a charge-discharge condition of the secondary battery based on the charge-discharge characteristics stored in the storage unit;
controlling, by the charge-discharge control unit, charge and discharge of the secondary battery based on the charge-discharge condition;
storing, in the storage unit, model data of degradation of the positive electrode, the negative electrode, and the secondary battery;
calculating by the charge-discharge control unit, charge-discharge characteristics of the positive electrode and charge-discharge characteristics of the negative electrode by comparing the model data stored in the storage unit with charge-discharge data of when the secondary battery is charged and discharged; and
determining, by the charge-discharge control unit, the charge-discharge condition of the secondary battery based on the calculated charge-discharge characteristics.
